(19) United States
(12) Patent Application Publication
(10) Pub. No.: US 2017/0062096 A1
(43) Pub. Date: Mar. 2, 2017

(54) CABLE, ESPECIALLY DATA TRANSFER CABLE, WIRE, AND METHOD FOR PRODUCING SUCH A WIRE

(71) Applicant: LEONI KABEL HOLDING GMBH, NUERNBERG (DE)

(72) Inventor: ERWIN KOEPPENDOERFER, SCHWABACH (DE)

(21) Appl. No.: 15/249,644

(22) Filed: Aug. 29, 2016

(30) Foreign Application Priority Data
Aug. 28, 2015 (DE) 10 2015 216 470.5

(51) Int. Cl. H01B 11/18; H01B 11/00; H01B 7/18; H01B 13/14; H01B 3/30; H01B 3/44

(52) U.S. Cl. CPC H01B 11/1834; H01B 3/308; H01B 3/441; H01B 11/1808; H01B 7/1875; H01B 13/141; H01B 11/002

(57) ABSTRACT

A cable, especially a data transfer cable, has at least one wire having an inner conductor and a wire sheath which has been applied directly thereto. The wire sheath has a dielectric layer composed of a foamed uncrosslinked thermoplastic polymer, preferably polyethylene or polypropylene, and the dielectric layer is encased by an outer skin layer composed of unfoamed, chemically crosslinked polyethylene. The specific wire sheath leads to a distinct improvement in soldering properties. Additionally specified are a corresponding wire and a production process therefor.

### CROSS-REFERENCE TO RELATED APPLICATION

This application claims the priority, under 35 U.S.C. §119, of German patent application DE 10 2015 216 470.5, filed Aug. 28, 2015; the prior application is herewith incorporated by reference in its entirety.

### BACKGROUND OF THE INVENTION

### Field of the Invention

The invention relates to a cable, especially a data transfer cable, to a wire for such a cable and to a method for producing such a wire.

There are cable constructions that are known in principle and comprise multiple layers of crosslinked polyethylene. In a so-called foam-skin PE cable for data transfer, one insulation layer used is a foamed polyethylene coated with a thin layer, which is also referred to as the outer skin or outer skin layer, as outer shell, with the whole structure being radiation-crosslinked. This involves exposing the initially uncrosslinked cable as a whole to a typically costly and inconvenient electron beam crosslinking operation. The result is that all the layers of polyethylene are at least partly physically crosslinked. Physically crosslinked polyethylene, according to general nomenclature, is referred to as PE-Xc.

Other cable constructions dispense entirely with crosslinking because of the high cost and inconvenience associated with electron beam crosslinking. For example, published patent application US 2013/0180752 A1 describes a cable having a dielectric layer composed of foamed polyethylene surrounding multiple inner conductors as dielectric and having, as outer layer, i.e. as outer skin, a high-density polyethylene, called HDPE for short. This layer construction is in widespread use and is adequate for many applications.

However, in cases where the inner conductor is to be connected to other conductors or contact elements by soldering, it has been found that a conventional construction melts very rapidly because of the action of heat during the soldering operation. This applies both to soldering of the inner conductor of a single wire and particularly also to soldering of any possible additional outer conductor, for example of a shielding layer in a data cable or an outer conductor in a coaxial cable. In the case of introduction of heat, the foamed dielectric layer typically collapses in on itself, which gives rise to an impedance defect which in turn typically disrupts data transfer. In the case of major defects in the dielectric, a short circuit can even arise. Conventional cable constructions are therefore suitable exclusively for manual soldering, the skill and speed of the solderer being noticeable factors here as to whether the cable is damaged or not. For industrial soldering, such a cable construction is therefore unsuitable because of the low capacities.

### SUMMARY OF THE INVENTION

Against this background, it is an object of the invention to provide a cable and a wire therefor which overcome the above-mentioned and other disadvantages of the heretofore-known devices and methods of this general type and which provide for a conductor and a foamed dielectric, wherein the conductor can be bonded to other components by automatic soldering. The cable is to withstand an input of heat in the course of soldering with a minimum level of damage. In addition, a production method for the wire is to be specified.

With the foregoing and other objects in view there is provided, in accordance with the invention, a cable, comprising:

at least one wire formed with an inner conductor and a wire sheath applied directly to said at least one wire;

said wire sheath having a dielectric layer composed of a foamed uncrosslinked thermoplastic polymer;

an outer skin layer composed of unfoamed, chemically crosslinked polyethylene encasing said dielectric layer.

The cable according to the invention is especially suitable to form a data transfer cable, for example a symmetrical data cable or coaxial cable. The cable has at least one wire having an inner conductor and a wire sheath which has been applied directly thereto and has a dielectric layer composed of a foamed uncrosslinked thermoplastic polymer, wherein the dielectric layer is encased by an outer skin layer composed of unfoamed, chemically crosslinked polyethylene. This wire sheath has been applied directly to a circumference, i.e. an outer face, of the conductor. The thermoplastic polymer from which the dielectric layer has been manufactured is especially an olefin, preferably a polyethylene or a polypropylene.

The advantages achieved by the invention are especially that the cable, also referred to hereinafter without restriction as data transfer cable, can be soldered in a particularly simple manner, meaning more particularly that the cable after a soldering operation does not have any impedance defect or any short circuit. The essential core idea here is especially the specific combination of an uncrosslinked polymer as dielectric layer and a chemically crosslinked polymer as outer skin layer. Compared to physically crosslinked, i.e. especially radiation-crosslinked, polyethylene, the particular technical advantage achieved is that exclusively the outer skin layer crosslinks. All other layers, by contrast, remain uncrosslinked. In this way, a costly and inconvenient radiation crosslinking is dispensed with and advantageously only the outer skin layer crosslinks, while the dielectric layer remains uncrosslinked, meaning that the wire sheath, so to speak, is merely locally crosslinked, namely in the region of the outer skin layer. An uncrosslinked polymer for formation of the dielectric layer has the advantage that better mechanical properties are achieved overall, as a result of which the wire having uncrosslinked polymer as dielectric, compared to a wire having crosslinked polymer, withstands a higher number of bending cycles without failure. More particularly, the local crosslinking also prevents a cohesive bond, such that the outer skin layer still remains intact, i.e. its structure is conserved, when the foamed dielectric layer collapses.

The wire consists of an inner conductor, for example a solid conductor or a stranded conductor, and a wire sheath applied directly to the circumference of the conductor. The wire sheath especially has multiple layers, but at least the dielectric layer and the outer skin layer. The dielectric layer serves for electrical insulation of the wire and preferably additionally ensures a certain distance between the inner conductor and adjacent components in the cable. The wire sheath has a total thickness and the dielectric layer a thickness that makes up a major proportion of the total thickness, preferably about 65% to 95%.

In a symmetrical data transfer cable having multiple wires, for example a paired data transfer cable or a star quad cable, the thickness of the dielectric layer especially achieves a defined distance between the wires, particularly the inner conductors of the wires. In a non-symmetrical data transfer cable, for example a coaxial cable, the dielectric layer achieves a defined distance between the inner conductor and a shield or outer conductor. Such a defined distance between different components efficiently avoids variations in impedance, which would otherwise lead to faults in the data transfer, for example as a result of reflections, which ultimately lowers the maximum possible data transfer rate.

The dielectric layer of the wire sheath has a layer of a foamed uncrosslinked thermoplastic polymer, especially an olefin-based thermoplastic polymer. The foaming has the advantageous effect that the relative permittivity, also called the dielectric coefficient, is lowered compared to an identical polymer in unfoamed form, which ultimately affects the impedance, dimensions, capacity and insulation in a known manner and, in this way, it is in turn possible to achieve a higher data transfer rate.

Around the dielectric layer, i.e. especially at an outer edge of the dielectric layer of uncrosslinked foamed thermoplastic polymer, is the outer skin layer, also called thin layer or outer skin, of unfoamed, chemically crosslinked polyethylene, which is also referred to as PE-Xa, PE-Xb, PE-Xd. In the case of PE-Xa peroxidic crosslinking is effected, in the case of PE-Xb silane crosslinking, and in the case of PE-Xd azo crosslinking in a salt bath. The outer skin layer advantageously forms a stable tube surrounding the dielectric layer, i.e. a layer of soft foamed uncrosslinked thermoplastic polymer. Should the amount of heat lead to partial melting of the dielectric layer at one end of the wire, the outer skin layer, because of its stability, forms sufficient protection at least against a short circuit of the inner conductor with other conductive components of the cable.

Experiments also showed that such an outer skin improves the solderability of the wire. This is especially attributed to the fact that the crosslinked polyethylene firstly itself has a higher sustained use temperature of especially up to 150° C. compared to a chemically uncrosslinked polyethylene having a sustained use temperature of especially about 85° C. The low thermal conductivity of the layers advantageously results in heating of the foamed dielectric layer to a lesser degree.

In a preferred variant, the thermoplastic polymer of the dielectric layer is a foamed polyethylene, PE-LD for short, meaning that the dielectric layer especially consists of PE-LD. This has the advantage that, because of the similar materials, a good connection to the outer skin layer is achieved.

In a preferred variant, the thermoplastic polymer of the dielectric layer is a foamed polypropylene, PP-E for short, meaning that the dielectric layer especially consists of PP-E. This has the advantage that, in the case of use of PP-E, a sustained use temperature up to 20° C. higher is achieved, which additionally improves solderability.

The outer skin layer has a thickness which is preferably in the range from 70 to 150 μm, i.e. micrometers, and is more preferably in the range from 80 to 120 μm. In the case of smaller thicknesses, it has been found that the heat capacity of the outer skin layer is inadequate, such that damage to the cable regularly occurs in the course of a soldering operation lasting about 10 seconds. The upper limit in the preferred range is caused particularly by the need for flexibility of the cable.

The outer skin layer appropriately has a crosslinking level G of greater than 50%, preferably greater than 60%. In the case of a lower crosslinking level, the sustained use temperature is typically too low. In the course of crosslinking, individual polymer chains form crosslinking sites with one another. The crosslinking level is determined especially by the number of crosslinking sites relative to the total number of polymer chains. More particularly, the crosslinking level is proportional to what is called the entanglement density.

The outer skin layer preferably consists of unfoamed silane-crosslinked polyethylene. According to nomenclature, this form of crosslinked polyethylene is referred to as PE-Xb. A silane-crosslinked outer skin layer achieves particularly good heat resistance in the course of soldering.

In a preferred development, an additional inner skin layer, inner skin for short, is formed especially as part of or as a further layer of the wire sheath. This inner skin layer is appropriately arranged directly at the circumference of the inner conductor, i.e. between the inner conductor and the dielectric layer. The inner skin layer in that case consists of unfoamed polyethylene in particular. Such an inner skin layer especially reduces heat transfer between the inner conductor and the dielectric layer, such that the soldering properties in the soldering of the inner conductor are significantly improved.

It is particularly advantageous here for the inner skin layer to be formed from a polyethylene which has especially been chemically crosslinked, as a result of which the wire is shielded particularly effectively from introduction of heat in the course of soldering.

Particular preference is given to a variant with an unfoamed and chemically crosslinked polyethylene, which results in a further improvement in the soldering characteristics, since the higher sustained use temperature of the inner skin layer in particular enables a significantly longer soldering time here compared to an unfoamed uncrosslinked polyethylene.

The inner skin layer preferably has a thickness of 25 to 100 μm, preferably 50 to 80 μm. The best soldering results were achieved in experiments with this thickness range.

The wire is particularly suitable for formation of the cable as a coaxial cable. In that case, this cable appropriately has an outer conductor surrounding the inner conductor and also the dielectric layer, and an outer shell surrounding the outer conductor. In that case, the outer conductor especially forms a shield for the inner conductor, i.e. is a shielding layer. By virtue of the abovementioned advantageous soldering properties, it is especially also the case that the structure of the coaxial cable is advantageously conserved in the course of soldering, particularly the distance between the inner and outer conductors defined by the dielectric layer. In this case, more particularly, soldering both of the inner conductor and of the outer conductor is possible with the advantages mentioned.

In a suitable variant, the coaxial cable consists of a wire having an inner conductor, preferably an inner skin layer applied directly to the inner conductor, a dielectric layer applied thereto, and an outer skin layer present at the outer edge of the dielectric layer, and also a shield and a shell. The shell is preferably an outer shell of the cable.

In a suitable variant, the cable is a symmetrical data cable having at least two wires each having an inner conductor and a wire sheath which has been applied directly thereto and has a dielectric layer composed of a foamed uncrosslinked thermoplastic polymer, wherein the respective dielectric layer is encased by an outer skin layer composed of unfoamed, chemically crosslinked polyethylene.

In a suitable variant, the symmetrical data cable consists of at least two wires, or else four, six or a higher even number of wires, each having an inner conductor, preferably an inner skin layer applied directly to the inner conductor, a dielectric layer applied thereto, and an outer skin layer present at the outer edge of the dielectric layer, and also an individual shield applied around all the wires, i.e. a common shielding layer, or shields each applied around two wires, and a shell which surrounds the individual shield or all the shields. In that case, the shell is especially an outer shell of the cable.

In an advantageous development, the cable has a shielding layer surrounding the wires. In other words, a shield has been applied or arranged around the outer skin layers of the wires, meaning that the shield surrounds at least the outer skin layers of two wires. The wires in such a cable have typically been stranded together and in that case have especially been twisted together. The shielding layer takes the form, for example, of a D shield, i.e. of a filament spun around the wires.

The shield, i.e. the shielding layer, particularly in the case of a coaxial cable and in the case of a symmetric data cable, and generally in the case of a cable, is preferably a C shield, i.e. a braided shield, or alternatively a D shield, i.e. helical or spiral shield, or an St shield, i.e. a static shield, for example a foil shield, which is also referred to as B shield. It is additionally possible for further shields to be arranged in further layers.

In an appropriate configuration, at least one shielding layer is applied or arranged directly on the outer skin layer, i.e. especially in contact with the outer skin layer. This especially achieves the effect that, in the course of soldering of the shielding layer, the outer skin layer absorbs the heat generated in the course of soldering and protects the layers beneath. It has been found that an outer skin layer composed of unfoamed, chemically crosslinked polyethylene arranged directly beneath the shielding layer drastically increases the duration of heating during soldering prior to impairment of the foamed dielectric layer, such that an automatic soldering operation can be used without any problems in the case of such a construction.

The entire coaxial cable or the symmetrical data cable appropriately has an outer shell, also referred to as cable shell, which is arranged around the wire and especially the shielding layer, and hence forms an outer layer. The outer shell is thus especially exposed directly to environmental influences and protects all inner layers and components from such environmental influences.

For the production of an electrical wire, an electrical conductor is first provided. This is guided through an extrusion head. The extrusion head is connected to two or more extruders. In this case, each extruder provides one material.

The dielectric layer is applied in that a dielectric extruder provides a foamed uncrosslinked thermoplastic polymer and applies this material around the conductor via a dielectric region in the extrusion head. In a suitable variant, the dielectric layer is extruded directly onto the conductor. The material for the dielectric layer is foamed physically or chemically. Chemical foaming is effected, for example, by introducing a blowing agent, for example azodicarbonamide, ADCA for short. Physical foaming is effected, for example, by introducing an inert gas, for example carbon dioxide or nitrogen.

In the dielectric extruder, preferably the material polyethylene or polypropylene is provided.

The outer skin layer is applied in that an outer skin extruder provides an unfoamed, chemically crosslinked polyethylene and this material is applied directly to the dielectric layer via an outer skin region in the extrusion head. Preferably, the chemically crosslinked polyethylene is obtained here by extrusion of components which have especially been mixed immediately upstream of the extrusion, composed of a silane-crosslinkable compound and a crosslinking activator, in the outer skin extruder. In other words, the components required for preparation of crosslinked polyethylene, which are especially first each provided in pellet form, are mixed prior to the extrusion. The mixing is effected either manually or preferably, however, directly in an intake zone of the outer skin extruder by means of a metering unit. Automatic mixing with the aid of a metering unit has exceptional process reliability. In the outer skin extruder, the molten compound and the molten crosslinking activator are then mixed. In that case, “immediately” means more particularly that the residence time of the components in the outer skin extruder is less than about 30 min, since crosslinking has already set in and, more particularly, is not yet complete when this mixing is effected in the outer skin extruder.

In a preferred variant, an inner skin layer is additionally applied to the inner conductor in that a polyethylene, especially an unfoamed polyethylene, is provided by an inner skin extruder and extruded directly onto the electrical conductor via an inner skin region in the extrusion head. Preferably, the inner skin layer is additionally produced especially in a similar manner to the outer skin layer as chemically crosslinked inner skin layer of polyethylene.

The extrusion head is appropriately a co-extrusion head, for extrusion of multiple layers around the inner conductor. In that case, the extrusion head has multiple stages, namely the inner skin region as the first region, the dielectric region as the second region and the outer skin region as the third region. In one variant, the extrusion head has only the two latter regions and, correspondingly, no inner skin layer is extruded.

The extrusion of the outer skin layer, the dielectric layer and the extrusion of any additional inner skin layer as well is especially effected in a multilayer method, i.e. a two- or three-layer method. In this case, the outer skin layer, the dielectric layer and, in the case of its presence, also the inner skin layer are applied in a common extrusion head and at the same time over the various regions of the extrusion head.

Other features which are considered as characteristic for the invention are set forth in the appended claims.

Although the invention is illustrated and described herein as embodied in a cable, especially data transfer cable, wire and method for producing such a wire, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a cross section through an electrical wire according to the invention;

FIG. 2 is a cross section through cable in the form of a coaxial cable according to the invention; and

FIG. 3 is a cross section through a cable in the form of a symmetrical data cable according to the invention.

### DETAILED DESCRIPTION OF THE INVENTION

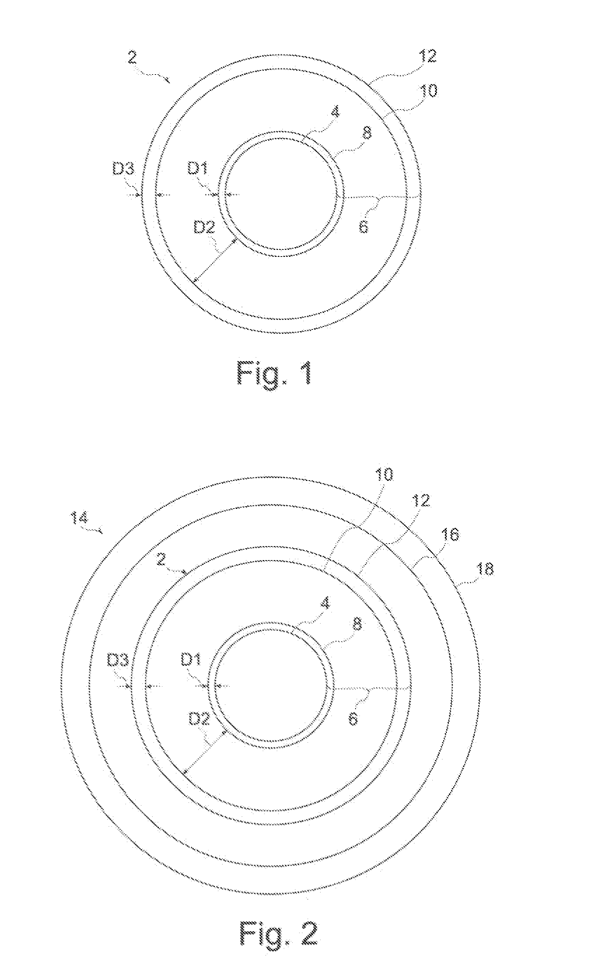

Referring now to the figures of the drawing in detail and first, particularly, to FIG. 1 thereof, there is shown a wire 2 having an inner conductor 4 and a wire sheath 6. In the working example shown here, the latter has an inner skin layer 8 and a dielectric layer 10. In a variant which is not shown, the inner skin layer 8 is dispensed with and the dielectric layer 10 is applied directly to the conductor 4. The wire 2 additionally has an outer skin layer 12 arranged around the dielectric layer 10. The dielectric layer 10 here has been manufactured from a foamed uncrosslinked thermoplastic olefin-based polymer.

In the working example shown here, the inner skin layer 8 has a thickness D1 of about 60 μm, the dielectric layer 10 has a thickness D2 of about 1.35 mm, and the outer skin layer 12 has a thickness D3 of about 90 μm. Thus, the thickness D2 of the dielectric layer makes up about 90% of a total thickness of the wire sheath 6.

FIG. 2 shows a cable 14 in the form of a coaxial cable. The cable 14 has a wire 2 according to FIG. 1, surrounded by an outer conductor 16. The inner conductor 4 and the outer conductor 16 thus form two concentric conductors of the coaxial cable, between which is arranged the dielectric layer 10 as dielectric having a particular thickness D2. Arranged around the outer conductor 16 is an outer shell 18. The outer conductor 16 additionally forms a shielding layer 20.

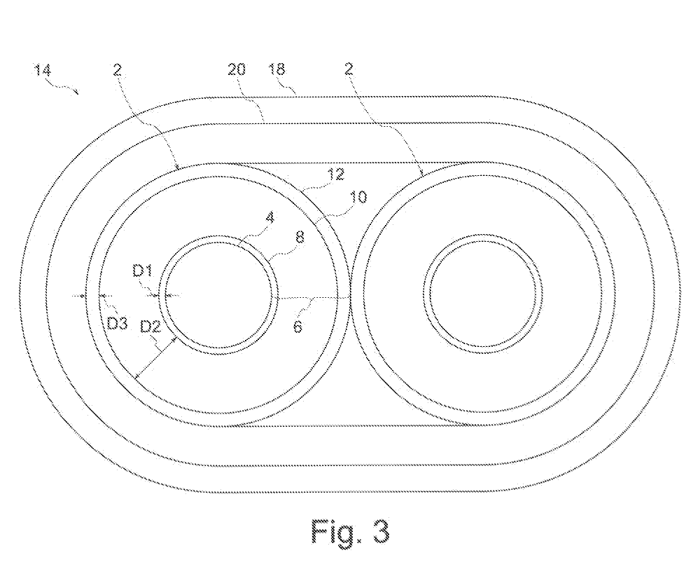

FIG. 3 shows a variant of the cable 14, which takes the form here of a symmetrical data cable, having two wires 2 each of the form according to FIG. 1. The two wires 2 are collectively surrounded by a shielding layer 20 surrounded in turn by an outer shell 18.

Table 1 below shows results from comparative tests of respective suitability for soldering compared to conventional cables from very poor (−−) to very good (++). Used here as a comparison, i.e. a reference, is a conventional wire 2 having only a conductor 4 of copper with a foamed dielectric layer 10 applied thereto as wire sheath 6.

TABLE 1

| | | | | Outer | | | |
|---|---|---|---|---|---|---|---|
| | Inner | Inner | Dielectric | skin | Outer | Outer | Suitability for |
| No. | conductor | skin layer | layer | layer | conductor | shell | soldering |
| Ref. | Cu | — | PE-LD or | — | — | — | −− |
| | | | PP-X/EPP | | | | |
| 1 | Cu | — | PE-LD | PE-Xb | — | — | + |
| 2 | Cu | PE-Xb | PE-LD | PE-Xb | — | — | ++ |
| 3 | Cu | PE-Xb | PE-LD | PE-Xb | D shield | PVC | Inner conductor ++ |
| | | | | | | | Outer conductor ++ |
| 4 | Cu | PE-Xb | PP-X/EPP | PE-Xb | D shield | PVC | Inner conductor ++ |
| | | | | | | | Shielding layer ++ |

In test series 1, a wire 2 having an inner conductor 4 composed of copper, without an inner skin layer 8, of a dielectric layer 10 composed of foamed uncrosslinked polyethylene, PE-LD for short, and of an outer skin layer 12 composed of unfoamed silane-crosslinked polyethylene, PE-Xb for short, without an outer conductor 16 or shielding layer 20 and without outer shell 18, was tested. This wire 2 already exhibits good soldering characteristics (+) in the case of soldering of the inner conductor 4 compared to wires according to the prior art.

In test series 2, a wire as shown in FIG. 1 was tested. The wire 2 consists of an inner conductor 4 composed of copper, of an inner skin layer 8 composed of unfoamed silane-crosslinked polyethylene, PE-Xb for short, of a dielectric layer 10 composed of foamed uncrosslinked polyethylene, PE-LD for short, and of an outer skin layer 12 composed of unfoamed silane-crosslinked polyethylene, PE-Xb for short, and has no outer conductor 16, no shielding layer 20 and no outer shell 18. Because of the inner skin layer 8, this wire 2 shows much better soldering characteristics (++) on soldering of the inner conductor 4 compared to test series 1.

In test series 3, a cable 14 in the form of a coaxial cable, as shown in FIG. 2, was tested. The coaxial cable consists of a wire 2 having an inner conductor 4 composed of copper, of an inner skin layer 8 composed of unfoamed silane-crosslinked polyethylene, PE-Xb for short, of a dielectric layer 10 composed of foamed uncrosslinked polyethylene, PE-LD for short, of an outer skin layer 12 composed of unfoamed silane-crosslinked polyethylene, PE-Xb for short, of an outer conductor 16, which is a D shield here, and of an outer shell 18 composed of PVC. Because of the inner skin layer 8, both the inner conductor 4 and the outer conductor 16 and hence the cable 14 have much better soldering characteristics (++) overall.

In test series 4, a data cable 14 in the form of a symmetric, i.e. paired, data cable, as shown in FIG. 3, was tested. The data cable consists of two mutually stranded wires 2 each having an inner conductor 4 composed of copper, of an inner skin layer 8 composed of unfoamed silane-crosslinked polyethylene, PE-Xb for short, of a dielectric layer 10 composed of foamed uncrosslinked polyethylene, PE-LD for short, an outer skin layer 12 composed of unfoamed silane-crosslinked polyethylene, PE-Xb for short, and of a shielding layer 20 which surrounds the two wires 2 and is a D shield here, and of an outer shell 18 composed of PVC that surrounds the shielding layer 20. Because of the inner skin layer 8, the wires 2 and the shielding layer 20 and hence the cable 14 show a distinct improvement in soldering characteristics (++) overall.

The following is a summary list of reference numerals and the corresponding structure used in the above description of the invention:

| | |
|---|---|
| 2 | wire |
| 4 | inner conductor |
| 6 | wire sheath |
| 8 | inner skin layer |
| 10 | dielectric layer |
| 12 | outer skin layer |
| 14 | cable |
| 16 | outer conductor |
| 18 | outer shell |
| 20 | shielding layer |
| D1, D2, D3 | thickness |

1. A cable, comprising:
at least one wire formed with an inner conductor and a wire sheath applied directly to said at least one wire;
said wire sheath having a dielectric layer composed of a foamed uncrosslinked thermoplastic polymer;
an outer skin layer composed of unfoamed, chemically crosslinked polyethylene encasing said dielectric layer.

2. The cable according to claim 1, wherein said thermoplastic polymer of said dielectric layer is a foamed polyethylene.

3. The cable according to claim 1, wherein said thermoplastic polymer of said dielectric layer is a foamed polypropylene.

4. The cable according to claim 1, wherein said outer skin layer has a thickness in a range from 70 to 150 μm.

5. The cable according to claim 1, wherein said outer skin layer has a level of crosslinking G of greater than 50%.

6. The cable according to claim 1, wherein said outer skin layer consists of unfoamed, silane-crosslinked polyethylene.

7. The cable according to claim 1, wherein said wire sheath has an inner skin layer manufactured from polyethylene.

8. The cable according to claim 7, wherein said inner skin layer is a layer manufactured from a crosslinked polyethylene.

9. The cable according to claim 7, wherein said inner skin layer has a thickness in a range from 25 to 100 μm.

10. The cable according to claim 1, being a coaxial cable having an outer conductor surrounding said inner conductor and being spaced apart therefrom by said dielectric layer, and having an outer shell surrounding said outer conductor.

11. The cable according to claim 1, being a symmetrical data cable having at least two wires each having an inner conductor, a wire sheath applied directly to said inner conductor and having a dielectric layer composed of a foamed uncrosslinked thermoplastic polymer, wherein the respective said dielectric layer is encased by an outer skin layer composed of unfoamed, chemically crosslinked polyethylene.

12. The cable according to claim 11, comprising a screening layer surrounding said at least two wires.

13. A wire for a cable according to claim 1, the wire comprising:
an inner conductor and a wire sheath applied directly to said inner conductor;
said wire sheath having a dielectric layer composed of a foamed uncrosslinked thermoplastic polymer, an outer skin layer composed of unfoamed, chemically crosslinked polyethylene encasing said dielectric layer, and an inner skin layer composed of unfoamed and uncrosslinked or chemically crosslinked polyethylene surrounded by said dielectric layer.

14. A method for producing an electrical wire, the method comprising:
providing an inner conductor;
guiding the inner conductor through a dielectric region and through an outer skin region of an extrusion head of an extrusion machine;
applying a dielectric layer composed of a foamed thermoplastic polymer in the dielectric region of the extrusion head; and
applying an outer skin layer composed of unfoamed, chemically crosslinked polyethylene in the outer skin region of the extrusion head;
to form an electrical wire with an inner conductor and a wire sheath applied directly to the inner conductor and the outer skin layer encasing the dielectric layer.

15. The method according to claim 14, wherein the thermoplastic polymer of the dielectric layer is composed of foamed polyethylene.

16. The method according to claim 14, wherein the thermoplastic polymer of the dielectric layer is composed of foamed polypropylene.

17. The method according to claim 14, wherein the chemically crosslinked polyethylene of the outer skin layer is formed by mixing a silane-crosslinkable compound with a crosslinking activator to give a mixture and then, after the mixing, extruding the mixture.

18. The method according to claim 14, which comprises, prior to the guiding the inner conductor through the dielectric region:
guiding the inner conductor through an inner skin region of the extrusion head and
applying an inner skin layer composed of polyethylene in the inner skin region of the extrusion head.
